(19) United States
(12) Patent Application Publication
(10) Pub. No.: US 2017/0085959 A1
(43) Pub. Date: Mar. 23, 2017

(54) ADAPTIVE MULTIMEDIA DISPLAY

(71) Applicant: International Business Machines Corporation, Armonk, NY (US)

(72) Inventors: Rachel H. Fithian, Raleigh, NC (US); Hugh E. Hockett, Raleigh, NC (US); Aaron J. Quirk, Cary, NC (US); David V. Rooney, Raleigh, NC (US)

(21) Appl. No.: 14/862,219

(22) Filed: Sep. 23, 2015

(51) Int. Cl. H04N 21/6377; H04N 21/2343; H04N 21/239; H04N 21/442; H04N 21/437

(52) U.S. Cl. CPC H04N 21/6377; H04N 21/44218; H04N 21/437; H04N 21/2393; H04N 21/234363

(57) ABSTRACT

An adaptive multimedia system includes a display and an adaptive display controller configured to communicate with a media stream source. The adaptive display controller selectively signals the media stream source to provide a media stream at a desired resolution based on one or more of a user preference, a size of the display, and a distance between a user and the display.

### BACKGROUND

The present invention relates to the art of multimedia displays and, more particularly, to an adaptive multimedia display.

Currently, many individuals stream multimedia data through an Internet connection to a display. The Internet connection may be established through a variety of providers including cable, satellite, and mobile device providers. The display could take the form of a smartphone, a computer monitor, a laptop computer, a tablet, or a television. The multimedia data is typically provided in a high resolution media stream that may be data intensive.

Often times, the high resolution media stream is not necessary, such as when viewed on smaller screens, at a distance, or by users with less than 20/20 vision. Further, there may exist a number of consumer frustrations associated with attempting to stream high resolution multimedia data, particularly when high resolution multimedia is not desired. For example, slower internet connections, multiple users at a location sharing a connection, provider imposed data quotas, and the like may impede a user from downloading high resolution media.

### SUMMARY

According to an embodiment of the present invention, an adaptive multimedia system includes a display and an adaptive display controller configured to communicate with a media stream source. The adaptive display controller selectively signals the media stream source to provide a media stream at a desired resolution based on one or more of a user preference, a size of the display, and a distance between a user and the display.

According to another embodiment of the present invention, a computer implemented method of adjusting a resolution of a media stream includes determining one of a user preference, a size of the display, and a distance between a user and the display, selecting a desired resolution of a media stream, communicating the desired resolution to a media stream source, and receiving, at the display, the media stream at the desired resolution.

According to yet another embodiment of the present invention, a computer program product for adjusting a resolution of a media stream includes a computer readable storage medium having computer readable program instructions embodied therewith. The program instructions are executable by a processor to perform a method including determining one of a user preference, a size of the display, and a distance between a user and the display, selecting a desired resolution of a media stream, communicating the desired resolution to a media stream source, and receiving, at the display, the media stream at the desired resolution.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts an adaptive multimedia system including an adaptive display controller, in accordance with an exemplary embodiment;

FIG. 2 depicts a block diagram illustrating the adaptive display controller, in accordance with an aspect of an exemplary embodiment;

FIG. 3 depicts a graph correlating user distance from a display, and display size with a desirable media resolution establishing a look-up table (LUT), in accordance with an aspect of an exemplary embodiment; and

FIG. 4 depicts a flow diagram of a method of adjusting a resolution of a media stream, in accordance with an aspect of an exemplary embodiment.

### DETAILED DESCRIPTION

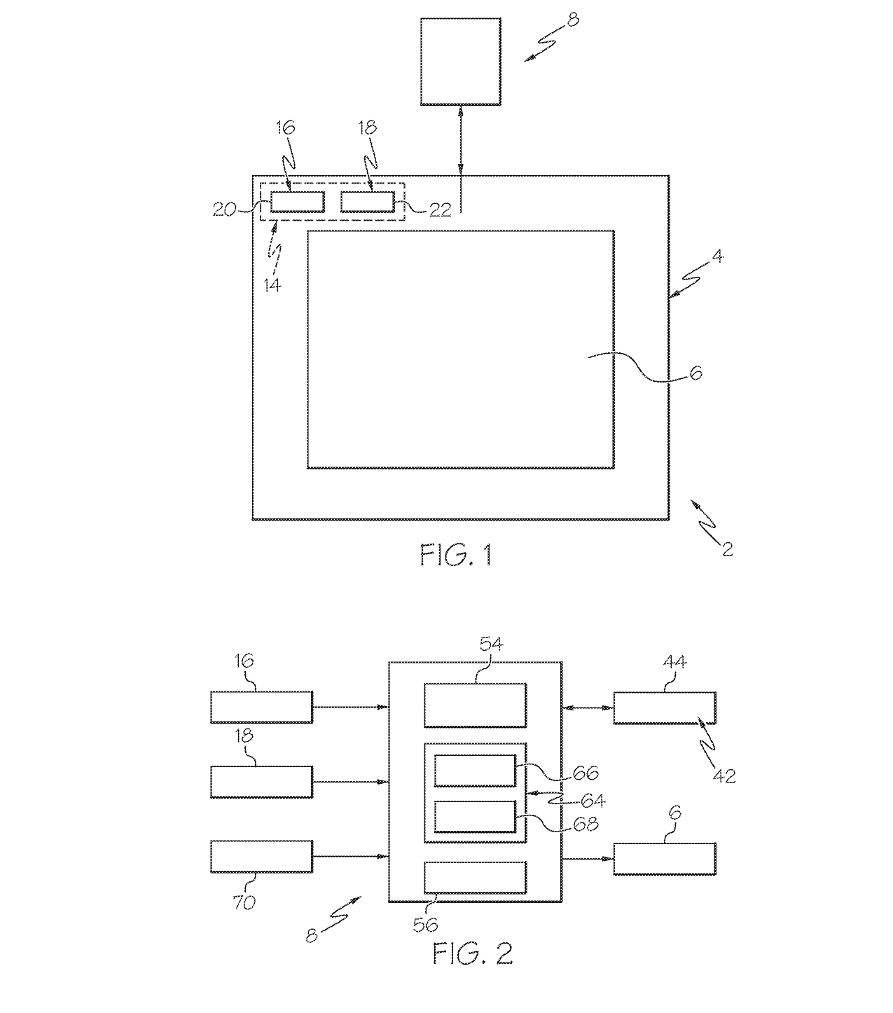

With reference to FIG. 1, an adaptive multimedia system, in accordance with an exemplary embodiment, is indicated generally at 2. Multimedia system 2 includes a housing 4 that supports a display 6 and an adaptive display controller 8. Multimedia system 2 may also include a sensor system 14 that cooperates with adaptive display controller 8 to establish a desired resolution of a media stream. Sensor system 14 may include a distance sensor 16 and an orientation sensor 18. Distance sensor 16 may take the form of an emitter/receiver device 20 that can determine a distance between a user and display 6. Distance sensor 16 could also take the form of a camera.

Orientation sensor 18 could take the form of a camera 22 operatively connected to an object recognition system (not shown) that can determine a relative orientation of a user relative to the display 6. Specifically, orientation sensor 18 may determine whether the user is facing display 6, facing away from display 6, and/or user posture. For example, orientation sensor 18 may determine whether a user is standing, is sitting, is lying down, or the like. Adaptive display controller 8 may rely on one or more inputs from sensor system 14 to determine a desired resolution of a media stream passing to adaptive multimedia system 2. At this point, it should be recognized that while described as separate sensors for detecting distance and orientation, sensor system 14 could rely on a single sensor, such as a camera, to determine distance and orientation.

Reference will now follow to FIG. 2 in describing adaptive display controller 8 in accordance with an aspect of an exemplary embodiment. As will be discussed more fully below, adaptive display controller 8 may connect to a content provider 42 through the Internet. Content provider 42 may constitute an internet service provider (ISP) 44. Alternatively, ISP 44 may simply serve as a gateway to another provider of video content. Adaptive display controller 8 may include a central processing unit (CPU) 54 and a communications device 56. Communications device 56 may take the form of a wireless communications device such as a Bluetooth® device, or a wired device that interfaces with content provider 42.

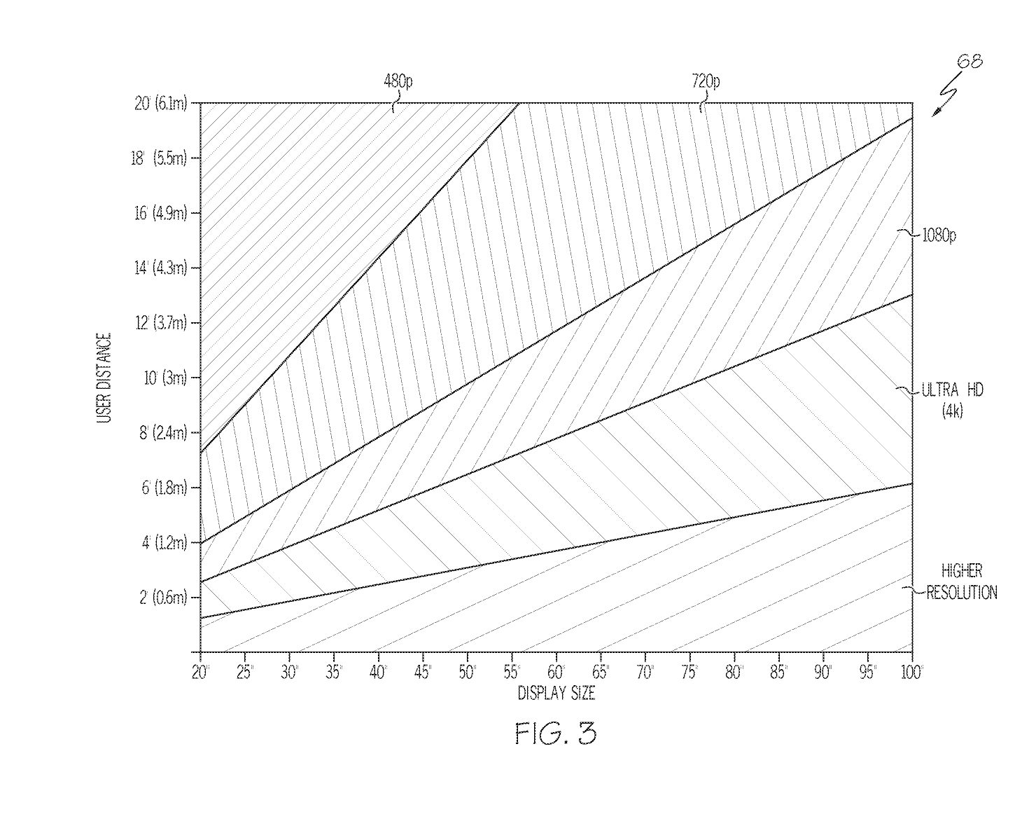

Adaptive display controller 8 may also include a non-volatile memory 64 having stored thereon user preferences 66 and a look-up table (LUT) 68. User preferences 66 may be input to non-volatile memory 64 through an input device 70 the form of which could vary. User preferences 66 could include one or more of a defined distance, a resolution gradient, and eyesight quality, including an eyeglass prescription as well as preferences for other options. Users with poor eyesight may not benefit from high resolution media. Similarly, users that are beyond a distance threshold from display 6 may not benefit from high resolution media. Thus, in addition to user defined preferences, LUT 68 provides a correlation between user distance from a display 6, display size, and desirable media stream resolution, such as shown in FIG. 3. As will be discussed more fully below, adaptive display controller 8, in response to user preferences 66 and/or LUT 68 as well as known properties, such as screen diagonal dimensions, may communicate a desired media resolution to content provider 42.

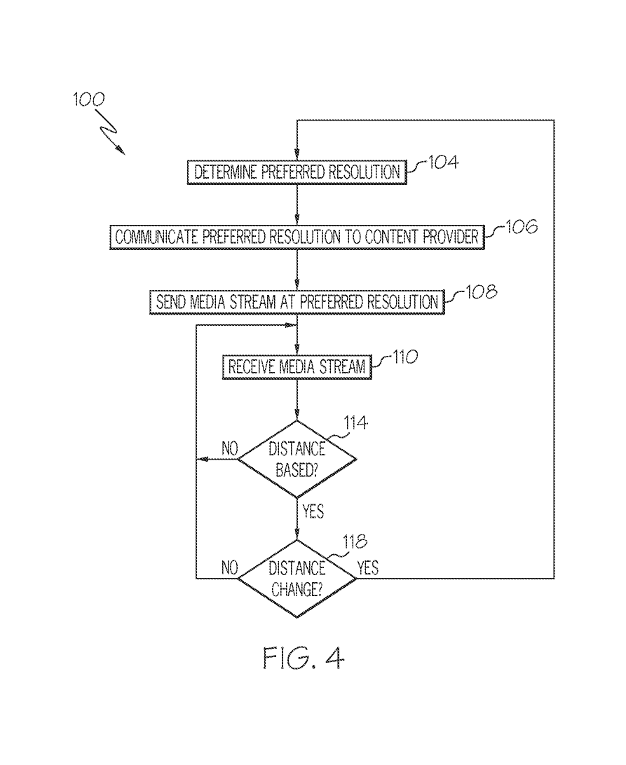

Reference will now follow to FIG. 4 in describing a method 100 of adaptively adjusting a resolution of a media stream. In block 104 a preferred resolution R_{P} is determined. R_{P} may be based on user selected preferences, values from LUT 68 and/or calculated as:

R_{P}=R_{O}*M

Where,

R_{O}=Original Resolution

M=Magnification factor

The magnification factor may be calculated as:

M=(D_{O}*K*Uₐ)/U_{d}

Where,

D_{O}=Physical diagonal measure of the display

U_{d}=Distance of user from display

Uₐ=User's visual acuity as a value between 0 and 1, based on their vision compared to someone with 20/20 vision.

K=1.6, a factor of known visual acuity of a human eye, for someone with 20/20 vision.

For example, user preferences and screen size may be read from non-volatile memory 64; a distance between a user and display 6 may be determined through distance sensor 16; and the distance may be correlated with screen size in LUT 68. Alternatively, the distance may be employed in the above calculation to determine R_{P}. R_{P} may additionally be based on the user's orientation relative to display 6. For example, orientation sensor 18 may determine the user's posture, e.g., sitting, standing, lying down, and/or whether the user is facing display 6 or facing away from display 6. Each determination may be relied upon by adaptive display controller 8 to estimate how long the user may be engaged with display 6 to establish R_{P} and determine whether a need for dynamic monitoring is indicated.

At this point, adaptive display controller 8 communicates the preferred resolution to content provider 42 in block 106. In block 108, content provider 42 streams media at the preferred resolution. In block 110, the media stream is received at multimedia system 2. If dynamic monitoring is indicated, in block 114, a determination may be made in block 118 whether the user has moved thereby changing the distance to display 6. If the distance has changed, method 100 may return to block 104 to establish a new R_{P}. If the distance remains the same, the media continues to stream to multimedia system 2 at the original R_{P}. In this manner, the user's visual experience viewing the media stream remains relatively unchanged.

At this point it should be understood that the exemplary embodiments describe a system for adaptively adjusting a resolution of a media stream to account for display size, user distance to a display, and user preferences. In this manner, the media stream may be tailored to specific circumstances, both physical and situational/positional, and/or additional preferences to selectively reduce download times, lagging, skipping, and data streaming costs. For example a user may be viewing a video on a smart phone. In such a case, a high media resolution may not be necessary. Thus, adaptive display controller can communicate with a content provider to stream the media at a lower resolution requiring less bandwidth. Accordingly, not only may the media stream faster, but costs that may be associated with streaming media may be lower. Additionally, the exemplary embodiments may tailor the media stream to a changing user position to enhance viewing experience.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An adaptive multimedia system comprising:
a display; and
an adaptive display controller configured to communicate with a media stream source, the adaptive display controller selectively signaling the media stream source to provide a media stream at a desired resolution based on a user preference including one of a user defined resolution gradient, and a user defined distance, and a size of the display.

2. The adaptive multimedia system according to claim 1, further comprising: a distance sensor operatively connected to the adaptive display controller, the distance sensor being configured to detect a distance between the user and the display.

3. The adaptive multimedia system according to claim 2, wherein the distance sensor comprises an emitter/receiver device.

4. The adaptive multimedia system according to claim 1, further comprising: an orientation sensor configured to detect an orientation of the user relative to the display.

5. The adaptive multimedia system according to claim 1, further comprising: a non-volatile memory having stored thereon user preferences associated with the media stream.

6. The adaptive multimedia system according to claim 5, wherein the user preferences further include eyesight quality.

7. The adaptive multimedia system according to claim 1, wherein the adaptive display controller is configured to dynamically establish the resolution of the media stream from the media stream source based on the distance between the user and the display.

8. The adaptive multimedia system according to claim 1, wherein the media stream comprises a multimedia stream.

9. A computer implemented method of adjusting a resolution of a media stream comprising:
determining a user preference including one of a user defined resolution gradient, and a user defined distance, and a size of the display;
selecting a desired resolution of a media stream;
communicating the desired resolution to a media stream source; and
receiving, at the display, the media stream at the desired resolution.

10. The computer implemented method of claim 9, further comprising:
determining a distance between a user and the display.

11. The computer implemented method of claim 9, further comprising:
determining an orientation of the user relative to the display.

12. The computer implemented method of claim 11, further comprising:
selecting the desired resolution based on the orientation of the user relative to the display.

13. The computer implemented method of claim 9, wherein determining the user preference further includes selecting user eyesight quality.

14. The computer implemented method of claim 9, further comprising: dynamically establishing the resolution of the media stream from the media stream source based on changes in the distance between the user and the display.

15. A computer program product for adjusting a resolution of a media stream, the computer program product comprising a computer readable storage medium having computer readable program instructions embodied therewith, the program instructions being executable by a processor to perform a method comprising:
determining a user preference including one of a user defined resolution gradient, and a user defined distance, and a size of the display;
selecting a desired resolution of a media stream;
communicating the desired resolution to a media stream source; and
receiving, at the display, the media stream at the desired resolution.

16. The computer program product of claim 15, further comprising:
determining a distance between a user and the display.

17. The computer program product of claim 15, further comprising:
determining an orientation of the user relative to the display.

18. The computer program product of claim 17, further comprising:
selecting the desired resolution based on the orientation of the user relative to the display.

19. The computer program product of claim 15, wherein determining the user preference further includes selecting user eyesight quality.

20. The computer program product of claim 15, further comprising:
dynamically establishing the resolution of the media stream from the media stream source based on changes in the distance between the user and the display.
